(19) United States
(12) Patent Application Publication
(10) Pub. No.: US 2023/0243971 A1
(43) Pub. Date: Aug. 3, 2023

(54) Lidar Interference Detection

(71) Applicant: OSRAM GmbH, München (DE)

(72) Inventors: Thomas Rossmanith, München (DE); Florian Kolb, Jena (DE)

(21) Appl. No.: 18/004,619

(22) PCT Filed: Jun. 22, 2021
(86) PCT No.: PCT/EP2021/066959

§ 371 Date: Jan. 6, 2023

(30) Foreign Application Priority Data
Jul. 7, 2020 (DE) 10 2020 208 476.9

(51) Int. Cl. G01S 17/89; G01S 7/4863; G01S 7/481

(52) U.S. Cl. CPC G01S 17/89; G01S 7/4863; G01S 7/4816

(57) ABSTRACT

In an embodiment, a LIDAR system includes a detector having a plurality of detector pixels configured to detect a light signal, wherein the detector pixels are arranged in a two-dimensional array, a light emission system configured to emit a light signal into a field of view of the LIDAR system and one or more processors configured to associate a first detected light signal provided by a first set of detector pixels of the plurality of detector pixels with a direct reflection of the emitted light signal and associate a second detected light signal provided by a second different set of detector pixels of the plurality of detector pixels with a light signal other than the direct reflection of the emitted light signal, wherein the one or more processors are configured to associate the second detected light signal with a light signal from an external emitter located outside the LIDAR system.

This patent application is a national phase filing under section 371 of PCT/EP2021/066959, filed Jun. 22, 2021, which claims the priority of German patent application 10 2020 208 476.9, filed Jul. 7, 2020, each of which is incorporated herein by reference in its entirety.

### TECHNICAL FIELD

Various embodiments relate to a LIDAR-system (i.e., a light detection and ranging system) and a method of operating a LIDAR-system.

### BACKGROUND

In general, various technologies are available to obtain detailed information about an environment, for example in the field of autonomous driving. Among these technologies, LIDAR-features the emission of measurement pulses into a scene. Light pulses (e.g., laser pulses) are emitted from a light source of a LIDAR-sensor, reflected from one or more objects, and finally detected by a detector of the LIDAR-sensor. Measuring the time of flight(s) (TOF) of the emitted light pulses enables the determination of information about the environment, e.g. about the presence of an object and/or about properties of the object (e.g. size, speed, direction of motion, or similar). However, there is always the risk that light pulses from LIDAR-sensors of other road users as well as multiple reflections of the own measurement pulse (so-called multi-path light signals) influence the own measurement.

### SUMMARY

According to various embodiments, an adapted measurement strategy for a LIDAR-system (also referred to herein as a LIDAR-sensor or LIDAR-sensor system) may be provided in which such light signals, which are typically considered unwanted noise or interfering signals and blocked (i.e., not detected), are instead detected and processed to provide additional information about the scene. The LIDAR-system described herein may have dedicated processing of light signals that are not related to the direct reflection of its own emitted light signals (e.g., light signals from other LIDAR-systems , indirect reflections of the emitted light signals, etc.). The processing of such light signals can provide additional application possibilities of the LIDAR-system (e.g. for data transmission).

In a common LIDAR-design, no or only very rudimentary (e.g. averaging of several measurements) precautions are taken to measure “opposing” LIDAR-light signals from other road users as well as own MultiPath light signals in order to then suppress them or to measure them and to obtain information for further measurement. Depending on the design of the LIDAR-sensor, only certain areas of a detector array corresponding to the (reception) direction of the emitted light signal are activated for each emitted light signal. Although this reduces the influence of background light (e.g. sunlight) and thus increases the signal-to-noise ratio, it does not provide any information about the origin of the interference pulses or the own MultiPath interference pulses. An exception to this are LIDAR-systems based on the FMCW method (Frequency Modulation Continuous Wave), since only signals that correspond to the FM modulation scheme are detected. It is possible (e.g. in the radar sector) to transmit a suitably coded pulse sequence and to set up the receiver in such a way that only this pulse sequence is registered as a valid measurement signal. However, this solution requires complex signal processing in the receiver.

According to various embodiments, the detector of a LIDAR-system may be set up (in some aspects, controlled) to measure “adversarial” light signals as well as its own MultiPath light signals (in addition to the direct reflections of its own light signals), so that its own measurement strategy may be modified accordingly to avoid erroneous measurements at its own LIDAR-system and/or at other LIDAR-systems. This reduces the possibility of mutual interference of several LIDAR-systems as well as the negative interference by own MultiPath light signals (viz. MultiPath sturgeon pulses). The LIDAR-system described herein is thus more robust against interferences, e.g. interferences by other LIDAR-systems or deliberately caused interfering radiation (e.g. by an attacker), since these can be detected and filtered out if necessary.

According to various embodiments, a LIDAR-system may comprise: a detector comprising a plurality of detector pixels arranged to detect a light signal, the detector pixels being arranged in a two-dimensional array; a light emission system arranged to emit a light signal into a field of view of the LIDAR-system; and one or more processors arranged to associate a first detected light signal provided by a first set of detector pixels of the plurality of detector pixels with a direct reflection of the emitted light signal, and to associate a second detected light signal provided by a second different set of detector pixels of the plurality of detector pixels with a light signal other than the direct reflection of the emitted light signal. The LIDAR-system described in this paragraph provides a first example.

A direct reflection of the emitted light signal can be understood as a light signal originating from the emitted light signal and arriving at the LIDAR-system from a receiving direction from the field of view that substantially corresponds to an emitting direction of the emitted light signal. In the context of this description, the term “direct reflection” may also describe a light signal originating from the direct reflection. An indirect reflection of the emitted light signal may be understood as a light signal originating from the emitted light signal and arriving at the LIDAR-system from a different receiving direction from the field of view than the emitting direction of the emitted light signal, as will be further explained below. In the context of this description, the term “indirect reflection” may also describe a light signal originating from the indirect reflection.

The light signal other than the direct reflection of the emitted light signal may be a light signal from an external emitter located outside the LIDAR-system (hereinafter referred to as external emitter) or an indirect reflection of the emitted light signal. The light signal other than the direct reflection of the emitted light signal is also called other light signal or external light signal in the following. Illustratively, the other light signal can be a light signal coming from outside the field of view and different from the direct reflection of the emitted light signal.

According to various embodiments, the one or more processors may be arranged to associate the first detected light signal with direct reflection (in other words, single reflection) of the emitted light signal, and to associate the second detected light signal with a light signal from an external emitter located outside the LIDAR system or with indirect reflection (in other words, multiple reflection or multi-path reflection) of the emitted light signal. The features described in this paragraph in combination with the first example provide a second example.

In the following, an external emitter may be described, for example, as another (external) LIDAR-system. It is understood that another LIDAR-system is only one example of a possible external emitter, and an external emitter can be any type of object from which light can originate (e.g., from which light can be emitted and/or scattered and/or reflected).

It is understood that more than one detected light signal may be associated with the direct reflection of the emitted light signal and/or more than one detected light signal may be associated with a light signal from an external emitter or the indirect reflection of the emitted light signal. For example, one detected light signal may be associated with a light signal from an external emitter and another detected light signal (e.g., detected by another set of detector pixels) may be associated with a light signal from another external emitter. As another example, a detected light signal may be associated with a light signal from an external emitter, and another detected light signal may be associated with indirect reflection of the emitted light signal.

The regions of the detector (also referred to herein as detector arrays) not used for detecting the direct reflection of the emitted light signal (in some aspects, the emitted laser pulse) are nevertheless activated and their signal is processed separately from their own Time of Flight timing. The one or more processors may be arranged to process a detected light signal depending on the particular assignment, e.g., to determine different types of information, as will be discussed in further detail below. For example, the one or more processors may be arranged to determine a time of flight of the emitted light signal using an arrival time on the detector of a light signal associated with the direct reflection of the emitted light signal. In some aspects, the detector pixels may be grouped together to be able to detect the magnitude of another light signal (in some aspects, the interference pulse) with reduced noise level.

The same resources can be used to process the direct reflection or the other light signals. For example, the same electronic components (e.g., same amplifier, same converter, same processors, etc.) may be used to process both the direct reflection of the emitted light signal and another light signal. Alternatively, components may be assigned to process the direct reflection and other components may be or become assigned to process other light signals.

According to various embodiments, the one or more processors may be arranged to associate the first detected light signal with the direct reflection of the emitted light signal and the second detected light signal with the light signal other than the direct reflection of the emitted light signal during a same detection period. The features described in this paragraph in combination with the first example or with the second example provide a third example.

In some aspects, a detection period may be or comprise a period of time during which a light signal is emitted by the light emission system and detected by the detector. In other aspects, a detection period may be or comprise a time period associated with detection of a light signal (in some aspects, detection of direct reflection of the light signal) emitted in an emission direction in the field of view (e.g., in an angular segment of the field of view). For example, another light signal (e.g., the second detected light signal) may be incident on the detector during the detection period associated with an emitted light signal.

According to various embodiments, the one or more processors may be arranged to associate the first detected light signal with the direct reflection of the emitted light signal, using a known direction of emission into the field of view of the emitted light signal, and/or using a known intensity of the emitted light signal. The features described in this paragraph in combination with any of examples one through three provide a fourth example.

The one or more processors may use known characteristics (e.g., a known modulation, such as intensity) of the emitted light signal to determine that a light signal impinging on the detector should be assigned to the direct reflection of the emitted light signal. The known characteristics of the emitted light signal may allow a received light signal to be unambiguously assigned to the direct reflection of the emitted light signal.

The one or more processors may be arranged to predict an arrival position (and/or a reception direction) of a direct reflection of the emitted light signal on the detector, using the known emission direction. In other words, the one or more processors may predict where on the detector a light signal originating from a direct reflection of the emitted light signal will or should arrive. For example, it may be determined that a detected light signal is or should be associated with the direct reflection of the emitted light signal if the detected light signal impinges on the detector at the expected arrival position of the direct reflection and if one or more properties of the detected light signal (e.g., intensity, pulse width, pulse duration, as examples) match (e.g., substantially match) the known properties of the emitted light signal.

According to various embodiments, the one or more processors may be arranged to control the detector such that the detector pixels associated with a predicted arrival position of the direct reflection of the emitted light signal are disabled during at least a portion of a detection period. The features described in this paragraph in combination with any of examples one through four provide a fifth example.

The detector pixels on which the direct reflection of the emitted light signal should impinge can be disabled so that another light signal can be detected (and processed) with reduced noise level, i.e. without interference from the emitted light signal and/or without using resources to process the direct reflection of the emitted light signal. At least part of an acquisition period may be allocated to the detection of other light signals.

According to various embodiments, the one or more processors may be arranged to associate the second detected light signal with the light signal other than direct reflection of the emitted light signal, using a distance between a position of the detector pixels of the first set of detector pixels within the two-dimensional array and a position of the detector pixels of the second set of detector pixels within the two-dimensional array. The features described in this paragraph in combination with any of examples one through five provide a sixth example.

Illustratively, a received light signal can be distinguished from a light signal associated with the direct reflection of the emitted light signal if an arrival position of the received light signal on the detector is at a distance from a (e.g., predicted) arrival position of the direct reflection of the emitted light signal.

For example, a received light signal may be associated with an external emitter or indirect reflection if a distance between the arrival position of the received light signal on the detector and the (e.g. predicted) arrival position of the direct reflection of the emitted light signal is greater than a threshold distance. The threshold distance may be adjusted, for example based on the resolution of the detector (e.g., on the number of detector pixels), e.g., the threshold distance may decrease as the resolution increases. As an example only, the threshold distance may be one detector pixel, for example three detector pixels, for example five detector pixels, or ten detector pixels.

For example, a received light signal may be associated with an indirect reflection of the emitted light signal if the received light signal is incident on the detector at a position other than the expected arrival position of the direct reflection and one or more characteristics of the received light signal match known characteristics of the emitted light signal, as will be discussed in further detail below. As another example, a received light signal may be associated with a light signal from an external emitter if the received light signal is incident on the detector at a position other than the expected arrival position of the direct reflection and one or more characteristics of the received light signal do not match known characteristics of the emitted light signal. As another example, a received light signal may be associated with a light signal from an external emitter if the received light signal is incident on the expected arrival position of the direct reflection on the detector, but one or more properties of the received light signal do not match known properties of the emitted light signal.

It is understood that the assignment using an arrival position of a detected light signal on the detector is only an example and other assignment strategies may be used. For example, the assignment may be made using a spot size of a detected light signal. Illustratively, a received light signal associated with the direct or indirect reflection of the emitted light signal may have a constant (known) spot size, but a received light signal originating from an external emitter may have a different spot size depending on the distance between the external emitter and the LIDAR-system. As another example, the mapping can be done using the intensity of a detected light signal. In the case where a received light signal originates from an external emitter (e.g., another LIDAR-system, e.g., a vehicle) and is directly incident on the detector, the light signal may have a high intensity, e.g., an intensity greater than a threshold (e.g., an intensity greater than an expected intensity of a light signal associated with direct or indirect reflection).

According to various embodiments, the one or more processors may be arranged to determine a position of the external emitter in the field of view, using a position of the detector pixels of the second set of detector pixels within the two-dimensional array. The features described in this paragraph in combination with the second example provide a seventh example.

The position of the external emitter in the field of view can be determined if the (second) detected light signal was assigned to a light signal from an external emitter. A position in the detector array can be assigned to a corresponding position in the field of view. The (X Y) coordinates of a detector pixel in the detector array can be assigned to the (XY) coordinates of a position (e.g., a region) in the field of view. Accordingly, there is a spatial relationship between the location of the detector pixel on the detector array and the transmitting position of the interfering source , so that the detection of a light signal (in some aspects, a pulse) on the detector array can in principle be used to infer the location of the origin of the received light signal (e.g., another LIDAR-sensor).

According to various embodiments, the one or more processors may be arranged to determine one or more characteristics of the external emitter, using a change in position of the second detected light signal within the two-dimensional array. The features described in this paragraph in combination with the seventh example provide an eighth example.

For example, the one or more characteristics may include a trajectory and/or a velocity and/or an acceleration of the external emitter. The change in position of the second detected light signal within the two-dimensional array may be determined over a plurality of detection periods. The determination of the one or more characteristics of the external emitter may be made if the second detected light signal has been associated with a light signal from an external emitter. The arrangement and measurement method described herein allow the direction of incidence and, if applicable, the trajectory of the interference pulses to be measured and instructions for further measurements to be derived therefrom. In some aspects, the one or more features may include a pulse repetition rate and/or a pulse emission pattern of the light signal associated with the external emitter. It is understood that the features described herein are provided as examples only, and other features may be determined based on detection of an external light signal.

The term trajectory can show the temporal change of a measurement signal (i.e. the pixel position of the interfering pulse on the detector array), from which the location, speed and acceleration of the interfering transmitter can be determined. Thus, stationary jammers can be distinguished from moving jammers. If the jammer is identified as belonging to an “enemy” vehicle, control variables (input) for the LIDAR-system can be obtained from the vehicle trajectory that can then be calculated.

According to various embodiments, the one or more processors may be arranged to associate the second light signal with a light signal from the external emitter and to associate a third detected light signal provided by a third set of detector pixels of the plurality of detector pixels with another light signal from the external emitter. The features described in this paragraph in combination with the eighth example provide a ninth example. For example, the third detected light signal may be detected by the detector in a further detection period.

According to various embodiments, the one or more processors may be arranged to determine the one or more characteristics of the external emitter using a difference between the position of the detector pixels of the third set of detector pixels within the two-dimensional array and the position of the detector pixels of the second set of detector pixels within the two-dimensional array. The features described in this paragraph in combination with the ninth example provide a tenth example.

Descriptively, the arrival position(s) of the light signal(s) associated with the external emitter on the detector can be tracked over time (e.g., over subsequent acquisition periods) to determine the one or more characteristics of the external emitter.

According to various embodiments, the one or more processors may be arranged to perform (in some aspects, support) an object recognition process using the determined position and/or the determined one or more features to recognize a type of the external emitter. The features described in this paragraph in combination with any of examples seven to ten provide an eleventh example.

Detection (and processing) of light signals that are not related to the direct reflection of the emitted light signal can provide additional information to improve the efficiency (e.g., increase the confidence level) of an object detection process. For example, detection of an adversarial LIDAR or other illumination unit can be used to make object detection more accurate. For example, the presence of a LIDAR or a trajectory of an opposing LIDAR may indicate a vehicle (e.g., a motor vehicle).

According to various embodiments, the one or more processors may be arranged to predict an expected arrival time and/or an expected arrival position of a further light signal from the external emitter on the detector. The features described in this paragraph in combination with any of examples two through eleven provide a twelfth example.

The prediction can be based on a type of external emitter. By logging the direction and timestamp of the detection of a “foreign” light signal over a longer period of time, it is possible to predict or generate different most likely hypotheses (based for example on different model assumptions, e.g. AI supported pattern recognition methods, which can be implemented in the one or more processors), when or where the next light signal from the external emitter can be expected. In LIDAR applications, AI supported methods are particularly useful due to the large amount of data, and are thus ideally suited for Deep Learning algorithms. Such model assumptions can, for example, represent typical, probable scenarios from which source the external signal originates (e.g. front LIDAR of an oncoming vehicle in the opposite lane, front/rear LIDAR of a stationary vehicle at the side of the road, front LIDAR of a vehicle at an intersection, rear LIDAR of a vehicle in front or stationary interference signal of an attacker, etc.).). When measuring from the direction of the “foreign” light signal, it is thus possible to estimate whether the received light signal was emitted by the own sensor or the “foreign” sensor.

According to various embodiments, the one or more processors may be arranged to control the light emission system in accordance with the determined position of the external emitter. The features described in this paragraph in combination with any of examples seven through twelve provide a thirteenth example.

The measurement strategy can be adapted based on the newly determined information. Direction (and timestamp) of detection of an external light signal can now be used to adjust the own measurement strategy. In some aspects, the adjustment of the measurement strategy can also be based on a determined type of external emitter.

According to various embodiments, the one or more processors may be arranged to control the light emission system such that the light emission system does not emit a light signal toward the position of the external emitter. The features described in this paragraph in combination with the thirteenth example provide a fourteenth example.

No light signal is emitted in the direction of the foreign pulse so as not to disturb the external emitter (e.g. a foreign LIDAR-sensor). The own LIDAR- system can detect the position of “foreign” LIDAR-sensors and by omitting the corresponding areas during its own measurement, it can disturb them less. When measuring from the direction of the foreign light signal, the measurement results can be discarded or not used for the own TOF measurement.

According to various embodiments, the one or more processors may be arranged to control the light emission system such that the light emission system emits the light signal in the direction of the position of the external emitter (or emits at least one light signal in the direction of the position of the external emitter). The features described in this paragraph in combination with the thirteenth example or the fourteenth example provide a fifteenth example.

For example, a light signal may be emitted from the LIDAR-system in the direction of the external emitter to transmit information to the external emitter, as will be discussed in further detail below. As another example, a light signal may be emitted from the LIDAR-system in the direction of the external emitter to repeat, assist, or verify an object recognition process to identify the emitter. The own LIDAR-sensor can correlate the position of “foreign” LIDAR-sensors with the detection of objects, e.g., another vehicle, and use this information to control the own LIDAR-system. For example, an emission in the direction of a real interfering transmitter (“opposing vehicle”) can be increased or decreased, depending on the reliability of the object detection.

According to various embodiments, the one or more processors may be arranged to generate a coded signal sequence and control the light emission system such that the light emission system emits the light signal in accordance with the coded signal sequence (or emits at least one light signal in accordance with the coded signal sequence). The features described in this paragraph in combination with any of examples one through fifteen provide a sixteenth example.

The light signal emitted according to the generated signal sequence may comprise a sequence of light pulses. The arrangement of light pulses within the sequence of light pulses may encode information that may be transmitted by the emitted light signal (e.g., to the external emitter, such as to another LIDAR-system). The one or more processors may, in some aspects, be arranged as encoders to generate an encoded sequence of analog signals (e.g., currents or voltages) for driving a light source of the light emission system. It is understood that a sequence of light pulses is only one example, and any type of encoding of information in a light signal may be used.

The detection and determination of the origin of enemy light signals also opens up the possibility of communicating with other LIDAR-sensors by means of suitably coded light signals (e.g. series of light pulses) (e.g. transmitting own position, speed, driving strategy). The LIDAR-sensors involved can exchange information. The measurement of true foreign light signals can be used, in some aspects, for “Line of Sight” data transmission, such as from vehicle to vehicle. As one example, a particular pulse scheme could encode warning information (e.g., braking at the end of a traffic jam) or status information of its own vehicle (position, speed, driving strategy, dimensions, object classification). The data transmission can be targeted in the desired direction (i.e. only in the direction of the communication partner) and does not have to take place in the entire field of view. Among other things, this allows greater security against eavesdropping attacks by third parties (e.g., against “man in the middle” attacks).

According to various embodiments, the one or more processors may be arranged to generate a first encoded signal sequence and a second encoded signal sequence and to control the light emission system such that the light emission system emits a first light signal in accordance with the first signal sequence in a first emission direction, and such that the light emission system emits a second light signal in accordance with the second signal sequence in a second emission direction. The features described in this paragraph in combination with the sixteenth example provide a seventeenth example.

Since the transmitted light beam of LIDAR-sensors often sweeps over the scene to be measured (beam deflection, e.g. with a moving mirror or other methods), the pulse scheme used for information transmission can be linked to the position of the beam deflection and thus different information can be sent in different emission directions (e.g. to different receivers). Data transmission can thus be angle-selective or object-selective.

According to various embodiments, the one or more processors may be arranged to associate the second detected light signal with the indirect reflection of the emitted light signal, using a known modulation of the emitted light signal. The features described in this paragraph in combination with any of examples one through seventeen provide an eighteenth example.

A detected light signal incident on a different position within the two-dimensional array than a predicted arrival position of the emitted light signal can be associated with an indirect reflection of the emitted light signal, based on known properties (e.g., on a known modulation) of the emitted light signal (and/or based on a predicted or determined scenario of the environment). A multiple reflection of the emitted light signal can be detected. Illustratively, a detected light signal may be associated with indirect reflection of the emitted light signal if one or more properties of the detected light signal (an intensity, a pulse duration, a pulse width, an arrangement of light pulses, etc.) correspond to one or more properties of the emitted light signal.

The modulation of the emitted light signal may comprise any type of modulation that may be used to emit light. In some aspects, the modulation of the emitted light signal can comprise a modulated intensity of the emitted light signal, as an example. In some aspects, the modulation of the emitted light signal can comprise a modulated sequence of light pulses, as another example. In some aspects, the modulation of the emitted light signal can have a modulated pulse duration and/or a modulated pulse width, as further examples.

The arrangement described here is suitable for detecting undesired multiple reflections (“multi-path”). For example, the emitted light signal or a part of it cannot be reflected directly back to the detector by reflecting surfaces, but only reaches the detector again via the detour of one or more diffusely reflecting or other reflecting surface(s). In this case, the emission direction of the emitted light signal and the reception direction of the received light signal no longer coincide. Thus, the pulse received via the detour no longer hits the expected detector pixel, but another pixel. By using pulse detection and, if necessary, time measurement for the other pixels, incorrect measurements due to multiple reflections can be corrected.

According to various embodiments, the light emission system may be arranged to sequentially emit a plurality of light signals in a plurality of emission directions in the field of view. The features described in this paragraph in combination with any of examples one through eighteen provide a nineteenth example.

The LIDAR-system may be set up as a scanning LIDAR-system, e.g., a one-dimensional (1D) scanning system or a two-dimensional (2D) scanning system. Illustratively, the light emission system may be arranged to scan the field of view (in some aspects, the scene) with the emitted light signal(s), e.g., along one field of view direction or along two field of view directions (e.g., along the horizontal direction and/or the vertical direction in the field of view). The scanning of the field of view can be performed using a (1D or 2D) scanning method, for example MEMS-based scanning, VCSEL-based scanning, scanning using Optical Phased Arrays (OPA) or MetaMaterials, as examples.

The light emission system may be arranged to emit a light signal in each emission direction of the plurality of emission directions within a scan cycle. In other words, the entire field of view may be scanned by the light emission system within one scan cycle. A scanning cycle may be understood as a period of time during which each reachable (angular) segment of the field of view is illuminated by the light signals emitted by the light emission system.

According to various embodiments, the one or more processors may be arranged to control the light emission system such that the light emission system does not emit the light signal in at least one emission direction of the plurality of emission directions within a scan cycle. The features described in this paragraph in combination with the nineteenth example provide a twentieth example.

For example, the one or more processors may be arranged to control the light emission system such that the light emission system does not emit the light signal during a first scan cycle in a first emission direction, and such that the light emission system does not emit the light signal during a second scan cycle in a second different emission direction. Turning off the LIDAR-emission at certain angular segments (in some aspects, MEMS positions) and measuring the extraneous noise pulses then present during this turn-off period can increase the signal-to-noise ratio. The extraneous interference pulses can be measured and their directions of incidence determined. The direction of incidence of the sum of all pulses can also be determined mathematically.

In some aspects, the at least one emission direction can be associated with the determined position of an external emitter. In some aspects, the at least one emission direction can be a predefined emission direction. Light is not emitted in the predefined emission direction within each sampling cycle. Illustratively, this type of shutdown and measurement can then occur over multiple scan cycles (in some aspects, MEMS cycles) in the same angular segment. The light emission may occur at a different time and thus at a different angular segment (in some aspects, at a different MEMS angular position). In comparison to the other measurements (position/direction of the single strobe pulses as well as position/direction of the sum values), random extraneous pulses, which are incident from different directions, can be detected or differentiated from directional LIDAR-strobe pulses from other vehicles. Continuous measurements can be used to obtain information about the direction of origin of the interference pulses, possibly even a kind of trajectory over the detector array. If this trajectory is stationary or continuous, the presence of a “real” object can be inferred and even the direction of motion can be determined.

According to various embodiments, the one or more processors may be arranged to control the light emission system such that the light emission system emits a first light signal having a first intensity in a first emission direction within a scan cycle, and such that the light emission system emits a second light signal having a second intensity in a second emission direction. The features described in this paragraph in combination with the nineteenth example or the twentieth example provide a twenty-first example.

The first intensity can be different from the second intensity (e.g. can be larger or smaller). The intensity of the emitted light signals may be modulated. The light emission system may be controlled such that it emits light signals in a plurality of emission directions, and such that at least one emitted light signal in one emission direction has a different intensity than another emitted light signal in another emission direction. The own measurement beam can be increased in intensity at certain times (in some aspects, MEMS angular positions) or decreased in intensity at the next measurement pass, which can correspond to a (fixed) modulation. This also allows to clearly detect interfering pulses as well as own MultiPathPulses (correlation with own intensity and direction of origin), as described above. It is understood that the modulation of intensity is only an example and other properties of the emitted light signals can also be modulated, as described above.

According to various embodiments, the one or more processors may be or include at least one of a microcontroller, an application specific integrated circuit (ASIC), or a field programmable gate array (FPGA). The features described in this paragraph in combination with any of examples one through twenty-one provide a twenty-second example.

It is understood that the types of processors described herein are examples only and any type of processing device and/or control device may be used. In the figures, the one or more processors are shown as a single device. However, it is understood that a plurality of devices may be present which together may implement the functionalities described with respect to the one or more processors.

According to various embodiments, the light emission system may include a light source arranged to emit light (in other words, emit light signals). The features described in this paragraph in combination with any of examples one through twenty-two provide a twenty-third example.

The light source may be or comprise a laser source. The laser source can be or comprise a laser diode (in some aspects, a plurality of laser diodes) or a laser bar, as examples. The laser source may be or comprise an edge emitter. Alternatively or additionally, the laser source may be or comprise a surface emitter.

According to various embodiments, the light source may include a plurality of emitter pixels, which may be arranged in a one-dimensional or two-dimensional emitter array. The features described in this paragraph in combination with the twenty-third example provide a twenty-fourth example.

In some aspects, the two-dimensional emitter array can have the same resolution and/or aspect ratio as the detector array. For example, the light emitter may be or comprise a two-dimensional VCSEL array. In some aspects, the light emission system can be configured for multi-wavelength emission.

According to various embodiments, the light emission system may include a first light source configured to emit light at a first wavelength and a second light source configured to emit light at a second wavelength different from the first wavelength. The features described in this paragraph in combination with the twenty-third example or the twenty-fourth example provide a twenty-fifth example.

Vehicle-to-vehicle data transmission with the LIDAR-system can also use light sources of multiple wavelengths, e.g., one wavelength can be used for distance measurement and another wavelength can be used for data transmission. Detector systems that can detect and process multiple wavelengths separately (e.g., stacked photodiodes, wavelength separation with one or more partially transparent mirrors and multiple detector chips) could be used for this purpose, as will be discussed in more detail below.

In some aspects, a first light signal (e.g., comprising a first wavelength) and a second light signal (e.g., comprising a second different wavelength) may be emitted in the same emission direction into the field of view with a time shift from each other. The velocity of an object illuminated by the first light signal and by the second light signal can be determined using the time shift and the arrival times of the first light signal and the second light signal on the detector.

According to various embodiments, the light emission system may include a beam control device configured to control an emission direction of the emitted light signal. The features described in this paragraph in combination with any of examples one through twenty-five provide a twenty-sixth example.

The beam control device may be or include a fine angle control element. The beam control device may be arranged (in some aspects, controlled) to scan the field of view with the emitted light signals.

According to various embodiments, the beam steering device may be or include at least one of a microelectromechanical system, an optical phased array, or a metamaterial surface. The features described in this paragraph in combination with the twenty-sixth example provide a twenty-seventh example.

For example, the microelectromechanical system may be a MEMS mirror or include a MEMS mirror. It is understood that the beam steering devices described herein are examples only, and any type of control of the direction of emission of light may be used.

According to various embodiments, the detector may include at least one photodiode configured to generate a signal when light (e.g., a light signal) is incident on the photodiode. The features described in this paragraph in combination with any of examples one through twenty-seven provide a twenty-eighth example.

For example, the at least one photodiode may be or include one of a pin photodiode, an avalanche photodiode, or a single photon avalanche photodiode. It is understood that the photodiodes described herein are only examples of one component of a detector, and any type of element may be used for light detection. For example, the detector may be or include a silicon photomultiplier.

According to various embodiments, the detector may include a plurality of photodiodes, wherein a first photodiode of the plurality of photodiodes is sensitive to light in a first wavelength range and a second photodiode of the plurality of photodiodes is sensitive to light in a second wavelength range. The features described in this paragraph in combination with the twenty-eighth example provide a twenty-ninth example.

For example, the photodiodes of the plurality of photodiodes may be stacked. In other words, the photodiodes can be stacked.

According to various embodiments, the detector may further comprise one or more amplifiers configured to amplify a detection signal generated by the detector pixels and/or comprise one or more analog-to-digital converters configured to convert the detection signal generated by the detector pixels. The features described in this paragraph in combination with any of examples one through twenty-nine provide a thirtieth example.

According to various embodiments, the detector may comprise a first sub-detector and a second sub-detector, wherein the first sub-detector is arranged to detect light in a first wavelength range and the second sub-detector is arranged to detect light in a second wavelength range. The LIDAR-system may include a receiver optics arrangement configured to direct light having a wavelength in the first wavelength range to the first subdetector and to direct light having a wavelength in the second wavelength range to the second subdetector. The features described in this paragraph in combination with any of examples one through thirty provide a thirty-first example.

For example, the receiver optics assembly may include at least one semi-transparent mirror with bandpass filter coating.

According to various embodiments, a LIDAR-system may comprise: a detector comprising a plurality of detector pixels arranged to detect a light signal, the detector pixels being arranged in a two-dimensional array; a light emitting system arranged to emit a light signal into a field of view of the LIDAR-system; wherein the detector is arranged such that within a detection period associated with detection of a direct reflection of the emitted light signal, the detector pixels arranged in the two-dimensional array at a position different from an expected arrival position of a direct reflection of the emitted light signal are active to detect one or more light signals not associated with the direct reflection of the emitted light signal. The LIDAR-system described in this paragraph provides a thirty-second example.

In some aspects, the detector pixels disposed in the two-dimensional array at a position different from an expected arrival position of the direct reflection of the emitted light signal may be active to detect one or more light signals associated with one or more external emitters disposed outside of the LIDAR-system and/or an indirect reflection of the emitted light signal.

The LIDAR-system according to the thirty-second example may include any feature of the LIDAR-system of examples one through thirty-one, as appropriate.

According to various embodiments, a vehicle may include a LIDAR-system according to any of examples one through thirty-two. The vehicle described in this paragraph provides a thirty-third example.

A method of operating a LIDAR-system may comprise: detecting a first light signal and a second light signal; associating the first detected light signal with a direct reflection of a light signal emitted by the LIDAR-system; and associating the second detected light signal with a light signal other than the direct reflection of the light signal emitted by the LIDAR-system. The method described in this paragraph provides a thirty-fourth example.

The method according to the thirty-fourth example may have any feature of examples one through thirty-two, as appropriate. Illustratively, the arrangement of the one or more processors may be viewed as corresponding method steps.

A computer program product may include a plurality of instructions stored in a non-transitory computer-readable medium that, when executed by one or more processors of a LIDAR-system according to any of examples one through thirty-two , cause the controlled LIDAR-system to perform the method according to the thirty-fourth example. The computer program product described in this paragraph provides a thirty-fifth example.

In the context of this description, a detected light signal may be understood as an incident light signal that impinges on the detector (illustratively, on one or more detector pixels) and causes the detector to provide a detection signal (e.g., an analog signal, such as a photocurrent or the like). In other words, a detected light signal may be understood as a received light signal received at the detector and a detection signal provided by the detector in response thereto. A detection signal may be associated with a detected light signal.

A light signal can be understood as any type of light that can be detected by a detector of the LIDAR-system. In some aspects, a light signal can comprise light coming from an object in the field of view, such as light emitted from the object (e.g., light emitted from another LIDAR-system) or light reflected or scattered from the object (e.g., reflection of light emitted by the LIDAR-system itself, reflection of sunlight, etc.). In some aspects, a light signal can include a light pulse or a plurality of light pulses. In some aspects, a light signal can carry information or data.

In the context of this description, a set of detector pixels may comprise one or more detector pixels of the detector. A set of detector pixels may have detector pixels that are arranged adjacent to each other in the detector array, e.g., detector pixels in a same area of the detector array. The shape and/or extent of the region may/may not depend on the detected light signal (see, for example, FIG. 1B and FIG. 1C). In some aspects, a set of detector pixels may comprise a column or a row of the detector array. In some aspects, a set of detector pixels may comprise a square region or a rectangular region of the detector array, as examples.

### BRIEF DESCRIPTION OF THE DRAWINGS

Examples of embodiments are shown in the figures and are explained in more detail below.

FIG. 1A shows a schematic representation of a LIDAR-system according to various embodiments;

FIGS. 1B and 1C each shows a schematic representation of a detector array of a LIDAR system according to different embodiments;

FIG. 2A shows a schematic representation of a vehicle comprising a LIDAR-system according to various embodiments; and

FIG. 2B shows a schematic representation of a detector array of a LIDAR-system according to various embodiments.

### DETAILED DESCRIPTION OF ILLUSTRATIVE EMBODIMENTS

In the following detailed description, reference is made to the accompanying drawings which form part of this description and in which specific embodiments in which the invention may be practiced are shown for illustrative purposes. Since components of embodiments may be positioned in a number of different orientations, the directional terminology is for illustrative purposes and is not limiting in any way. It is understood that other embodiments may be used and structural or logical changes may be made without departing from the scope of protection of the present invention. It is understood that the features of the various exemplary embodiments described herein may be combined, unless otherwise specifically indicated. Therefore, the following detailed description is not to be construed in a limiting sense, and the scope of protection of the present invention is defined by the appended claims. In the figures, identical or similar elements are given identical reference signs where appropriate.

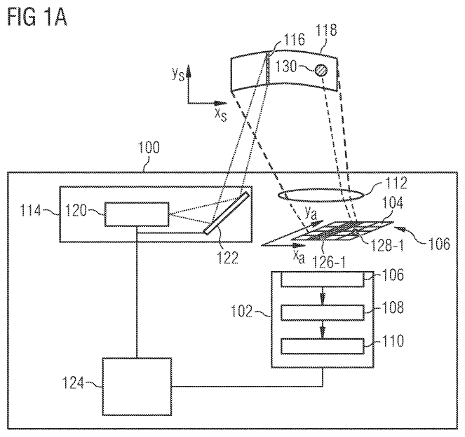

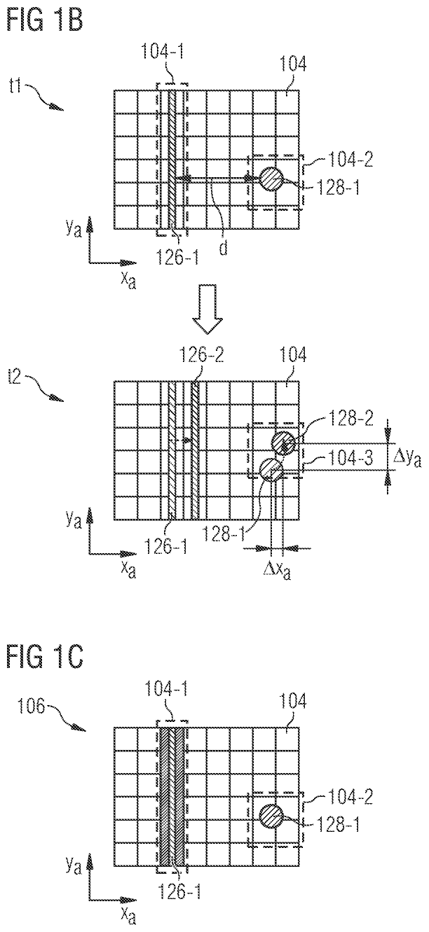

FIG. 1A shows a LIDAR-system wo in a schematic view, according to various embodiments.

The LIDAR-system wo may include a detector 102 comprising a plurality of detector pixels 104. The detector pixels 104 of the plurality of detector pixels 104 may be arranged in a two-dimensional array 106. In other words, the detector pixels 104 may be arranged along a first (e.g., horizontal) direction xa and along a second (e.g., vertical) direction ya to form an array 106. The array 106 is shown in FIG. 1A both as a component of the detector 102 and in a perspective view to illustrate the spatial relationship between the array 106 and the field of view of the LIDAR-system 100, as will be discussed in further detail below.

The array 106 is shown in the figures as a square or rectangular array. However, it is understood that the array 106 may have another shape (e.g., a cruciform shape, etc.). The array 106 may have a number of detector pixels 104, which may be selected based on a desired resolution. As a numerical example only, the array 106 may have 32×32 detector pixels 104, for example 64×64 detector pixels 104, for example 128×128 detector pixels 104.

The detector 102 may be arranged to detect light (e.g., light signals from a field of view 118 of the LIDAR-system 100). The detector pixels 104 may be arranged to detect a light signal (e.g., a first light signal 1261 and a second light signal 1281). Illustratively, the detector pixels 104 may be arranged to generate a detection signal (e.g., a photocurrent) in response to a light signal impinging on the detector pixels 104. As one example, the detector 102 may include at least one photodiode (e.g., a pin photodiode, an avalanche photodiode, or a single photon avalanche photodiode) configured to generate a detection signal (analog) when light (e.g., when a light signal) is incident on the photodiode. In some aspects, at least one detector pixel 104 may include or be associated with a photodiode. In some aspects, each detector pixel 104 may include or be connected to a respective photodiode. As another example, the detector 102 may be or comprise a silicon photomultiplier.

The detector 102 may be configured to detect light signals in the visible and/or infrared wavelength range (e.g., from 700 nm to 2000 nm). In some aspects, different detector pixels 104 (e.g., different photodiodes) may be associated for detecting different wavelengths. A first detector pixel 104 may be associated for detecting a first wavelength (e.g., a first photodiode may be sensitive to light in a first wavelength range), such as in the visible wavelength range, and a second detector pixel 104 may be associated for detecting a second wavelength (e.g., a second photodiode may be sensitive to light in a second wavelength range), such as in the infrared wavelength range. Different wavelengths may each be associated with different applications. In some aspects, the detector 104 may include a plurality of sub-detectors, for example each associated with a wavelength range. Each sub-detector may include a respective plurality of detector pixels, for detecting light in the associated wavelength range. For example, a first sub-detector may be arranged to detect light in a first wavelength range (e.g., in the visible wavelength range), and a second sub-detector may be arranged to detect light in a second wavelength range (e.g., in the infrared wavelength range).

The detector 102 may include electronics for pre-processing a detected light signal. The detector 102 may include an amplifier 108 configured to amplify a detection signal generated by the detector pixels 104. The detector 102 may include an analog-to-digital converter no configured to convert (e.g., digitize) a detection signal generated by the detector pixels 104. The digitized detection signal may be transmitted to one or more processors 124 of the LIDAR-system 100. It is understood that the amplifier 108 and the analog-to-digital converter no are only examples of possible electronic components, and other (different) components may be present. It is understood that the detector 102 may also include a plurality of amplifiers and/or a plurality of converters, e.g., assigned to process different types of detected light signals, as has been described above.

The LIDAR-system 100 may include a receiver optics arrangement 112 configured to direct light from the field of view 118 of the LIDAR-system to the detector 102. The receiver optics arrangement 112 may include one or more optical components (e.g., one or more lenses). In some aspects, the receiver optics arrangement 112 may be configured to direct received light signals in different directions depending on the respective wavelength. In this configuration, the receiver optics arrangement 112 can include at least one semi-transparent mirror with bandpass filter coating, by way of example. For example, the receiver optical arrangement 112 may direct a light signal having a wavelength in a first (e.g., visible) wavelength range to one (first) sub-detector and direct another light signal having a wavelength in a second (e.g., infrared) wavelength range to another (second) sub-detector.

The LIDAR-system 100 may include a light emission system 114 configured to emit light (e.g., a light signal 116) into the field of view 118 of the LIDAR-system 100. The field of view 118 may be an emission field of the light emission system 114 and/or a field of view of the detector 102.

The light emission system 114 may include a light source 120 configured to emit light (e.g., light signals). The light source 120 may be arranged to emit light in the visible and/or infrared wavelength range, for example, in the wavelength range from ₇00 nm to 2000 nm, for example, around 905 nm or around 1550 nm. The light source 120 may be configured to emit laser light. For example, the light source 120 may be or include a laser light source (e.g., a laser diode, a laser bar, etc.).

The light source 120 may be arranged to emit light having wavelengths in different wavelength ranges. In some aspects, the light source 120 (or light emission system 114) may include a first light source configured to emit light at a first wavelength (e.g., in the visible wavelength range or at a first infrared wavelength), and a second light source configured to emit light at a second wavelength (e.g., in the infrared wavelength range, such as at a second different infrared wavelength). In some aspects, the different wavelength ranges may be used for respective different applications, e.g., for time-of-flight measurements and for data transmission, as examples.

The light emission system 114 may be arranged to scan the field of view 118 with the emitted light (in other words, with the emitted light signals). The light emission system 114 may be arranged to sequentially emit a plurality of light signals 116 in a plurality of emission directions in the field of view 118. In other words, the light emission system 114 may be arranged to emit a plurality of light signals 116 along a scan direction or two scan directions. In FIG. 1A, the light emission system 114 is shown such that it scans the field of view 118 along the horizontal field of view direction xs with a light signal 116 that extends over the entire extent of the field of view 118 in the vertical field of view direction ys (1DScanning). It is understood that this is only one scanning option and other configurations are possible. For example, the light emission system 114 may scan the field of view 118 along the vertical field of view direction ys with a light signal that extends along the entire extent of the field of view 118 in the horizontal field of view direction xs. As another example, the light emission system 114 may scan the field of view 118 along the horizontal field of view direction xs and the vertical field of view direction ys with a point-shaped light signal (2DScanning).

In some aspects, the light source 120 may include a plurality of emitter pixels that may be arranged in a two-dimensional emitter array (e.g., the light source 120 may be or include a VCSEL array). Sequential activation of juxtaposed emitter pixels may enable scanning of the field of view 118 along one or two field of view directions.

In some aspects, the light emission system 114 may include a beam control device 122 configured to control an emission direction of the emitted light signal 116. Scanning the field of view 118 may be performed by controlling the beam control device 122 (by one or more processors 124 of the LIDAR-system 100). The beam control device 122 may be arranged to direct the light emitted from the light source 120 into the field of view 118 along one or two scan directions. For example, beam steering device 122 may be a MEMS mirror or include a MEMS mirror, but other types of devices may be used to control the direction of emission of light into field of view 118, as described above.

A scan of the entire field of view 118 using the light signals emitted by the light emission system 114 may be performed over a scan cycle. In other words, the light emission system 114 may be arranged to emit a light signal in each emission direction of the plurality of emission directions within a scan cycle (i.e., in each emission direction along the scan direction). As one example, all emitter pixels of an emitter array may be sequentially activated within a scan cycle. As another example, the beam steering device 122 may direct light emitted from the light source 120 in any possible emission direction within a scan cycle. In some aspects, a scan cycle may be a MEMS cycle in which a MEMS mirror assumes every possible actuation position (e.g., every possible tilt position).

The LIDAR-system wo may include one or more processors 124 for processing data and controlling the component of the LIDAR-system 100 (e.g., for processing detection signals and controlling the detector 102 and/or the light emission system 114, for example, for controlling the light source 120 and/or the beam steering device 122). The one or more processors 124 are shown in Figure IA as a single device. However, it will be understood that the one or more processors 124 may also be viewed as a plurality of data processing devices and control devices.

The one or more processors 124 may be arranged to discriminate and classify (and process accordingly) light signals incident on the detector 102 (on the array 106). The detector 102 may be arranged (in some aspects controlled) such that each detector pixel 104 is active or is activated (in a or each detection period). Illustratively, not only the detector pixels 104 associated with an expected arrival position of the direct reflection of the emitted light signal 116 may be active, but also the other detector pixels 104 of the array 106 (to detect other light signals).

The one or more processors 124 may be arranged to associate a first detected light signal 1261 provided by a first set 1041 (see FIG. 1B) of detector pixels 104 of the plurality of detector pixels 104 with a direct reflection of the emitted light signal 116, and to associate a second detected light signal 1281 provided by a second different set 1042 (see FIG. 1B) of detector pixels 104 of the plurality of detector pixels 104, to a light signal 130 other than the direct reflection of the emitted light signal 116.

The one or more processors 124 may associate the first detected light signal 1261 with the direct reflection of the emitted light signal 116, using a known direction of emission into the field of view 118 of the emitted light signal 116 and/or using a known intensity of the emitted light signal 116. The first detected light signal 1261 may be associated with the direct reflection of the emitted light signal 116, for example, if the coordinates xa ya on the array 106 where the first detected light signal 1261 impinges are associated with (or correspond to) the coordinates xs ys in the field of view 118 into which the light signal 116 was emitted. The first detected light signal 1261 can be associated with the direct reflection of the emitted light signal 116, for example, if the intensity of the first detected light signal 1261 corresponds to or is correlated with the intensity of the emitted light signal 116, for example, also in a time course.

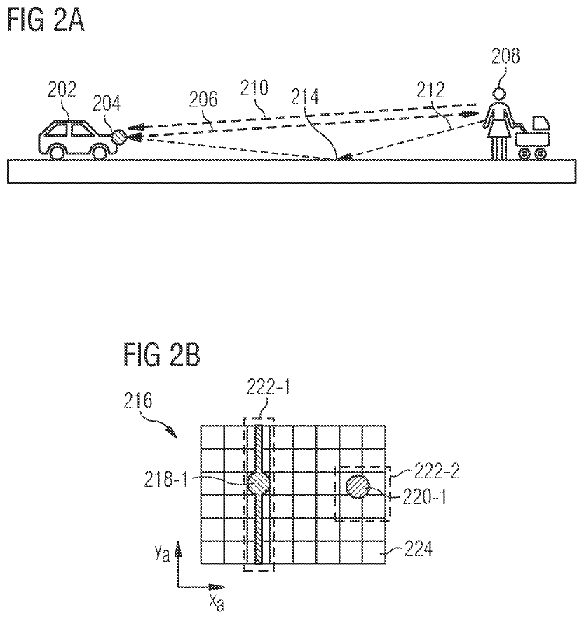

The one or more processors 124 may predict an expected arrival position on the array 106 of the direct reflection of the emitted light signal 116 using the known direction of emission. Illustratively, the one or more processors may determine the coordinates xa ya on the array 106 where the direct reflection (see also FIG. 2) of the emitted light signal 116 should strike based on the coordinates xs ys in the field of view 118 into which the light signal 116 was emitted. If a light signal is detected by a set of detector pixels 104 at the predicted coordinates xa ya on the array 106, this detected light signal can be assigned to the direct reflection of the emitted light signal 116 (e.g., also using known characteristics of the emitted light signal 116 as described above).

The one or more processors 124 may associate the second detected light signal 1281 with a light signal from an external emitter located outside the LIDAR-system 100 or with an indirect reflection of the emitted light signal 116, as will be discussed in further detail below (see also FIG. 2A and FIG. 2B).

The assignment of the detected light signals is shown in further detail in FIG. 1B and FIG. 1C.

The first detected light signal 1261 and the second detected light signal 1281 may be detected by the detector 102 during the same (first) detection period t1. Illustratively, (all of) the detector pixels 104 may be active within an acquisition period associated with the detection of the direct reflection of an emitted light signal 116, such that other (external) light signals may also be detected during this acquisition period. The one or more processors 124 may associate the first detected light signal 1261 with the direct reflection of the emitted light signal 116 and the second detected light signal 1281 with the external light signal 130 during the same detection period t1. The first detected light signal 1261 and the second detected light signal 1281 may be incident on the detector 102 at different times within the first detection period t1.

The one or more processors 124 may perform the assignment of a detected light signal based on the respective arrival position on the array 106. The second detected light signal 1281 may be associated with the light signal 130 other than the direct reflection of the emitted light signal 116, using a distance d between a position of the detector pixels 104 of the first set 1041 of detector pixels 104 within the two-dimensional array 106 and a position of the detector pixels 104 of the second set 1042 of detector pixels 104 within the two-dimensional array 106. The distance d may be a distance between a detected light signal associated with the direct reflection of the emitted light signal 116 and another detected light signal (e.g., between the (expected) arrival position of the first detected light signal 1261 and the arrival position of the second detected light signal 1281). The second detected light signal 1281 may be associated with an external emitter or indirect reflection of the emitted light signal 116 if the distance d is greater than a threshold distance (e.g., greater than one detector pixel, greater than five detector pixels, or greater than ten detector pixels).

The assignment may also be performed or supported using one or more properties of a detected light signal. For example, the second detected light signal 1281 may be associated with an external emitter if the one or more characteristics of the second detected light signal 1281 (e.g., an intensity, a pulse duration, a pulse width, a pulse sequence) do not match (in other words, are substantially different from) the one or more characteristics of the emitted light signal 116. As another example, the second detected light signal 1281 may be associated with indirect reflection if the one or more characteristics of the second detected light signal 1281 match (otherwise expressed substantially match) the one or more characteristics of the emitted light signal 116.

One or more characteristics of the external emitter can be determined using an associated detected light signal.

A position of the external emitter in the field of view 118 may be determined based on the arrival position of the associated light signal on the array 106. For example, the one or more processors 124 may determine the position of the external emitter in the field of view 118 using a position of the detector pixels 104 of the second set 1042 of detector pixels 104 within the two-dimensional array 106 (e.g., if the second detected signal 1281 was associated with an external emitter). The one or more processors 124 may determine the field-of-view coordinates xs ys of the external emitter based on the array coordinates xa ya of the associated light signal (illustratively based on the array coordinates xa ya of the arrival position of the second light signal 1281).

The one or more processors 124 may determine one or more characteristics of the external emitter (e.g., a trajectory and/or a velocity and/or an acceleration), using a change in the position of the associated detected light signal 1281 within the two-dimensional array 106. As shown in FIG. 1B, the position of a light signal associated with the external emitter may change on the array 106, for example, over subsequent detection periods.

The position of a light signal associated with the external emitter (e.g., the second detected light signal 1281) may change from the first detection period t1 to a second detection period t2. Illustratively, a third detected light signal 1282 may be provided by a third set 1043 of detector pixels 104 of the plurality of detector pixels 104, which may be associated with a further (external) light signal from the external emitter. The third detected light signal 1282 may be substantially the same as the second detected light signal 1281, except that it impinges on the array 106 at a different location.

The second detection period t2 may be associated with detecting the direct reflection of a further emitted light signal emitted in a further emission direction into the field of view 118. This is exemplified by the fourth detected light signal 1262, which is associated with the direct reflection of the further emitted light signal (and impinges on the array 106 at a different location than the first detected light signal 1261).

The one or more characteristics of the external emitter may be determined, using a difference between the respective arrival positions of the associated detected light signals. The one or more processors 124 may determine the one or more characteristics of the external emitter, using a difference between the position of the detector pixels 104 of the third set 1043 of detector pixels 104 within the two-dimensional array 106 and the position of the detector pixels 104 of the second set 1042 of detector pixels 104 within the two-dimensional array 106. A difference Δxa between the horizontal coordinate xa of the second detected light signal 1281 and the horizontal coordinate xa of the third detected light signal 1282, and a difference Δya between the vertical coordinate ya of the second detected light signal 1281 and the vertical coordinate ya of the third detected light signal 1282 may be used to determine a trajectory of the external emitter in the field of view 118. Illustratively, the difference between the array coordinates xa, ya may be associated with (or proportionally correspond to) a difference between the field of view coordinates xs, ys of the emitter. A velocity and/or an acceleration of the external emitter may be determined using the change in position of the detected light signal and a time difference between the first detection period t1 and the second detection period t2 (e.g., between the respective arrival times on the detector 102 of the light signals). It is understood that the determination of the characteristics of the external emitter may be performed over more than two acquisition periods, e.g., the light signal associated with the external emitter may be “tracked” over more than two acquisition periods.

The determined position and/or the determined characteristics of the external emitter may also be used to classify (e.g., recognize and classify) the external emitter. The one or more processors 124 may perform or support an object recognition process (and/or an object classification process) using the determined position and/or the determined one or more properties to recognize a type of the external emitter. For example, the one or more processors 124 may perform simulations (e.g., AI-assisted modelling techniques) that determine a (most likely) type of the external emitter, based on the determined positions and properties.

The detection of the external emitter may be used to predict a ratio of the external emitter. For example, the one or more processors 124 may predict an expected arrival time and/or an expected arrival position of another light signal from the external emitter on the detector 102. For example, the prediction may be based on a known pulse repetition rate of the external emitter (e.g., an external LIDAR-system).

The light emission of the LIDAR-system 100 may be adjusted using the additional information (e.g., the information about the external emitter). The one or more processors 124 may control the light emission system 114 in accordance with the determined position (and/or characteristics) of the external emitter.

In some aspects, the one or more processors 124 may control the light emission system 114 such that the light emission system 114 does not emit a light signal in the direction of the position of the external emitter. This may allow the light emission or light detection of the external emitter to not be interfered with by the LIDAR-system loo's own light emission.

In some aspects, the one or more processors 124 can control the light emission system 114 such that the light emission system 114 emits the light signal 116 toward the position of the external emitter. This may enable data transmission to the external emitter, as well as further adjustment of the object detection process (e.g., if a confidence level is below a desired threshold).

The data to be transmitted may be or may be encoded in an emitted light signal (e.g., in the emitted light signal 116). The one or more processors 124 may generate an encoded signal sequence and control the light emission system 114 such that the light emission system 114 emits the light signal 116 in accordance with the encoded signal sequence. For example, the light signal emitted in accordance with the generated signal sequence may comprise a sequence of light pulses. For example, the presence of a light pulse in the sequence may correspond to a binary value “1” and a gap may correspond to a binary value “o”, as an example.

The data transmission can be targeted, i.e. it can be performed (only) in the desired direction. The LIDAR-system wo can perform a “Line of Sight” data transmission with the desired “interlocutor” (e.g. the external emitter). The data transmission can be customized based on the interlocutor. Illustratively, different information can be encoded and transmitted at different external emitters. The encoded signal sequence according to which a light signal to be transmitted is generated can be customized based on the external emitter (e.g., the type thereof).

The one or more processors 124 may generate different signal sequences for data transmission using different emitters. For example, the one or more processors 124 may generate a first encoded signal sequence and a second encoded signal sequence and control the light emission system 114 such that the light emission system 114 emits a first light signal in accordance with the first signal sequence in a first emission direction, and that the light emission system 114 emits a second light signal in accordance with the second signal sequence in a second emission direction. The first emission direction may be associated with the position of a first external emitter (e.g., of a first type, such as a LIDAR-sensor), and the second emission direction may be associated with the position of a second external emitter (e.g., of a second type, such as a traffic station).

The light emission of the light emission system 114 can be adjusted to detect external light signals in a more efficient manner (e.g., with less noise). In some aspects, the light emission can be periodically turned off (e.g., for one detection period or for multiple detection periods) so that external light signals can be detected without interference from the LIDAR-system 100's own emission. The signal-to-noise ratio of the detection of the external signals can be increased.

The one or more processors 124 may control the light emission system 114 such that the light emission system 114 does not emit the light signal in at least one emission direction of the plurality of emission directions within a scan cycle. The light emission may be turned off in at least one of the emission directions within a scan cycle.

The light emission may be turned off in the same emission direction within each scan cycle, or may be turned off in a respective emission direction in different scan cycles (e.g., adjusted based on the position of an external emitter). The one or more processors 124 may control the light emission system 114 such that the light emission system 114 does not emit the light signal during a first scan cycle in a first emission direction, and such that the light emission system 114 does not emit the light signal during a second scan cycle in a second different emission direction.

Alternatively or additionally, the detection of the light signals may be adjusted to detect external light signals with less noise. For example, the detector pixels 104 on which an arrival position of the direct reflection of the emitted light signal 116 is expected to occur may be disabled (see FIG. 1C, where the detector pixels 104 on which the first detected light signal 1261 is incident are greyed out). The one or more processors 124 may control the detector such that the detector pixels 104 associated with a predicted arrival position of the direct reflection of the emitted light signal 116 are disabled during at least a portion of a detection period. Illustratively, detector pixels 104 located at array coordinates xa ya associated with field of view coordinates xs ys into which the light signal 116 was emitted may be deactivated.

In some aspects, a detected light signal (e.g., the second detected light signal 1281 or a further detected light signal) may be associated with an indirect (multiple) reflection of an emitted light signal (e.g., the emitted light signal 116), as described above and further discussed with reference to FIG. 2A and FIG. 2B.

FIG. 2A illustrates a vehicle 202 that includes a LIDAR-system 204. The LIDAR-system 204 may be or may be set up like the LIDAR-system 100. The LIDAR-system 204 may include a detector comprising a plurality of detector pixels 224 arranged in a two-dimensional array 216. It is understood that the scenario and application illustrated in FIG. 2A is only an example to illustrate multiple reflection of a transmitted light signal, and that other configurations or implementations may be possible.

The LIDAR-system 204 (e.g., a light emission system) may emit a light signal 206 that is reflected from an object 208 (e.g., a passerby). A direct reflection 210 of the emitted light signal 206 and an indirect reflection 212 of the emitted light signal 206 may originate from the object 208. The indirect reflection 212 may be a combination of specular and/or diffuse reflection from objects and surfaces in the field of view, e.g., from the object 208 and from a surface 214 (e.g., the road surface).

Both a light signal coming from the direct reflection 210 of the emitted light signal 206 and another (or more) light signal(s) coming from the indirect reflection 212 of the emitted light signal 206 are incident on the detector of the LIDAR-system 204. As shown in FIG. 2B, a first detected light signal 2181 and another (second) light signal 2201 may be incident on the array 216 of the detector of the LIDAR-system 204. The object 208 (and the surface 214) may serve as, or be perceived as, a “virtual” external emitter of the further light signal 2201.

The one or more processors of the LIDAR-system 204 may associate the first detected light signal 2181 provided by a first set 2221 of detector pixels 224 of the plurality of detector pixels 224 with the direct reflection 210 of the emitted light signal 206. The one or more processors of the LIDAR-system 204 may associate the further detected light signal 2201 provided by a further set 2222 of detector pixels 224 of the plurality of detector pixels 224 with the indirect reflection 212 of the emitted light signal 206, for example using a known modulation of the emitted light signal 206. Illustratively, the one or more processors may determine that a light signal detected at a location other than the direct reflection 210 of the emitted light signal 206 is also associated with the emitted light signal 206 based on known characteristics of the emitted light signal 206.

In some aspects, the known modulation of the emitted light signal 206 may include a modulated intensity of the emitted light signal 206. The one or more processors can control the light emission system such that the light emission system emits a first light signal having a first intensity in a first emission direction within a scan cycle, and such that the light emission system emits a second light signal having a second intensity in a second emission direction. The first intensity may be different from the second intensity (e.g., may be greater or less). In other words, the one or more processors may control the light emission system such that it emits light signals with different intensities at different times. Modulation of the intensity may allow light signals originating from an indirect reflection of the emitted light signal to be identified. These light signals can be processed accordingly, for example they can be considered for ToF measurement.

Although the invention has been illustrated and described in detail by means of the preferred embodiment examples, the present invention is not restricted by the disclosed examples and other variations may be derived by the skilled person without exceeding the scope of protection of the invention.

1.-10. (canceled)

11. A LIDAR system comprising:
a detector comprising a plurality of detector pixels configured to detect a light signal, wherein the detector pixels are arranged in a two-dimensional array;
a light emission system configured to emit a light signal into a field of view of the LIDAR system; and
one or more processors configured to associate a first detected light signal provided by a first set of detector pixels of the plurality of detector pixels with a direct reflection of the emitted light signal and associate a second detected light signal provided by a second different set of detector pixels of the plurality of detector pixels with a light signal other than the direct reflection of the emitted light signal,
wherein the one or more processors are configured to associate the second detected light signal with a light signal from an external emitter located outside the LIDAR system.

12. The LIDAR system according to claim 11, wherein the detector is configured to detect light signals having different wavelength, and wherein the second detected light signal comprises a wavelength different from a wavelength of the detected first light signal.

13. The LIDAR system according to claim 12, wherein the one or more processors are configured to determine a position of the external emitter within the field of view, using a position of the detector pixels of a second set of detector pixels within the two-dimensional array.

14. The LIDAR system according to claim 13,
wherein the one or more processors are configured to determine one or more characteristics of the external emitter, using a change in position of the second detected light signal within the two-dimensional array, and
wherein the one or more characteristics comprise a trajectory and/or a velocity and/or an acceleration of the external emitter.

15. The LIDAR system according to claim 13,
wherein the one or more processors are configured to control the light emitting system in accordance with the determined position of the external emitter, and
wherein the one or more processors are configured to control the light emitting system such that the light emitting system does not emit a light signal towards the position of the external emitter.

16. The LIDAR system according to claim 13,
wherein the one or more processors are configured to control the light emitting system in accordance with the determined position of the external emitter, and
wherein the one or more processors are configured to control the light emission system such that the light emission system emits the light signal in a direction of the position of the external emitter.

17. The LIDAR system according to claim 11, wherein the one or more processors are configured to associate the first detected light signal with the direct reflection of the emitted light signal and the second detected light signal with the light signal other than the direct reflection of the emitted light signal during the same detection period.

18. The LIDAR system according to claim 11, wherein the one or more processors are configured to associate the second detected light signal with the light signal other than the direct reflection of the emitted light signal using a distance between a position of the detector pixels of the first set of detector pixels within the two-dimensional array and a position of the detector pixels of a second set of detector pixels within the two-dimensional array.

19. The LIDAR system according to claim 11, wherein the one or more processors are configured to generate a coded signal sequence and to control the light emitting system such that the light emission system emits the light signal in accordance with the coded signal sequence.

20. A LIDAR system comprising:
a detector comprising a plurality of detector pixels configured to detect a light signal, wherein the detector pixels are arranged in a two-dimensional array,
wherein the detector is arranged such that within a detection period associated with a detection of a direct reflection of an emitted light signal, the detector pixels arranged in the two-dimensional array at a position different from an expected arrival position of the direct reflection of the emitted light signal are active to detect one or more external light signals not associated with the direct reflection of the emitted light signal.

21. A method for operating a LIDAR system, the method comprising:
detecting a first light signal and a second light signal;
associating the first detected light signal with a direct reflection of a light signal emitted by the LIDAR system; and
assigning the second detected light signal to a light signal other than the direct reflection of the light signal emitted by the LIDAR system.
